(19) United States
(12) Patent Application Publication
(10) Pub. No.: US 2024/0255906 A1
(43) Pub. Date: Aug. 1, 2024

(54) SYSTEM AND METHOD FOR DETERMINING DEMAND SHEDDING EVENTS FOR ENERGY MANAGEMENT

(71) Applicant: Walmart Apollo, LLC, Bentonville, AR (US)

(72) Inventors: Mandeep Singh, Bangalore (IN); Viraj Chimanlal Patel, Bentonville, AR (US); Ashish Gupta, Bangalore (IN); Devanand Guruprasad Chintoju, Bentonville, AR (US); Abhishek Mishra, Bengaluru (IN); Aaron Wayne Ray, Lowell, AR (US)

(73) Assignee: Walmart Apollo, LLC, Bentonville, AR (US)

(21) Appl. No.: 18/118,402

(22) Filed: Mar. 7, 2023

Related U.S. Application Data
(60) Provisional application No. 63/442,170, filed on Jan. 31, 2023.

(51) Int. Cl. G05B 19/042; G06N 20/20

(52) U.S. Cl. CPC G05B 19/042; G06N 20/20; G05B 2219/2639

(57) ABSTRACT

A method including determining, via a machine learning model, a predicted energy load profile for a facility based at least in part on weather forecast data and sensor data for the facility. The sensor data can be received from one or more energy monitoring sensors for one or more devices in the facility. The method further can include determining one or more demand shedding time slots based at least in part on peak periods and the predicted energy load profile. Moreover, the method can include determining one or more demand shedding events for the one or more devices to be scheduled during the one or more demand shedding time slots. The method additionally can include causing a respective performance of each of the one or more demand shedding events by the one or more devices during the one or more demand shedding time slots. Other embodiments are disclosed.

### CROSS-REFERENCE TO RELATED APPLICATIONS

This application claims priority to U.S. Provisional Patent Application No. 63/442,170, filed Jan. 31, 2023. U.S. Provisional Patent Application No. 63/442,170 is incorporated herein by reference in its entirety.

### TECHNICAL FIELD

This disclosure relates generally to techniques for facilitating energy management.

### BACKGROUND

Existing technologies for energy management generally focus on two major approaches, reducing energy consumption and/or switching to renewable sources of energy. Reducing energy consumption not only contributes to the public goods of sustainability but also brings economic benefits to the consumers. In particular, reducing peak energy consumption (“demand shedding”) can lead to considerable economic savings. Conventional demand shedding techniques generally are reactive and cannot act at the right timing. Systems and methods for proactively determining demand shedding events based on predicted peak loads are desired.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a system for determining demand shedding events for energy management, according to an embodiment; and

FIG. 4 illustrates a flow chart for a method for determining demand shedding events for energy management, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, ten seconds, thirty seconds, one minute, five minutes, ten minutes, etc.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### Description of Examples of Embodiments

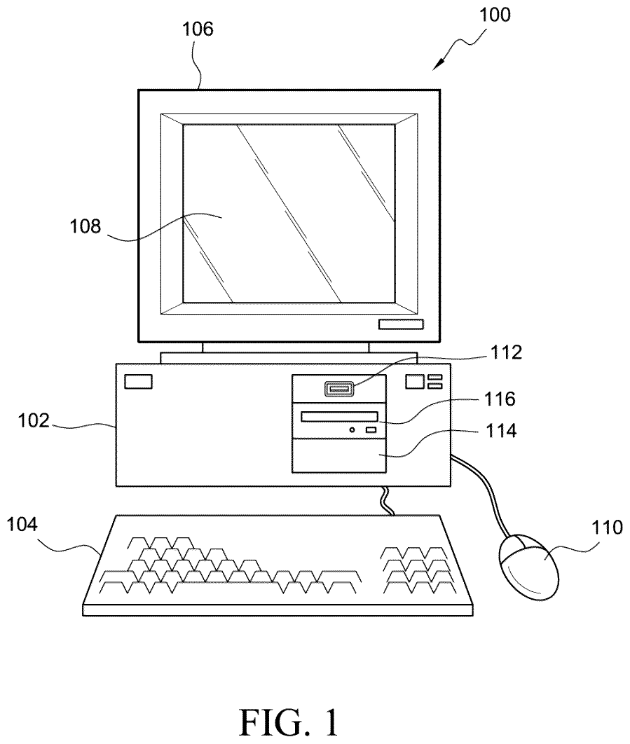

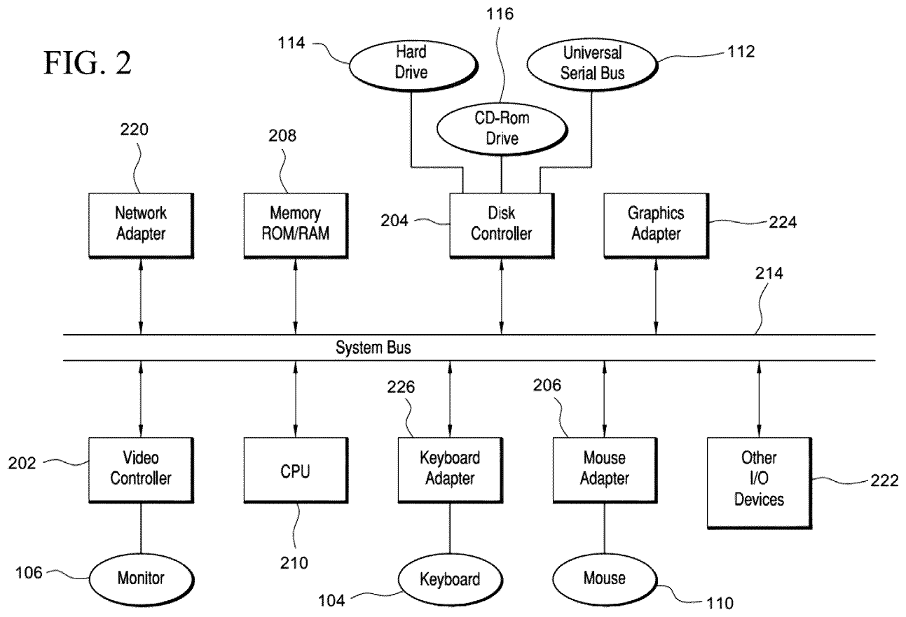

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can includes one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

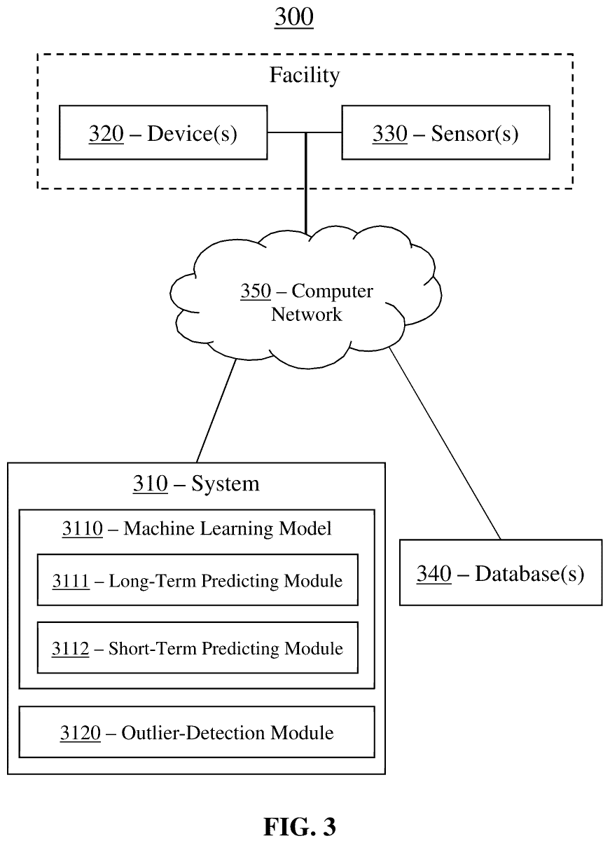

Turning ahead in the drawings, FIG. 3 illustrates a block diagram of a system 300 that can be employed for determining demand shedding (or load shedding) events for energy management, according to an embodiment. Exemplary demand shedding events can include events that when taken place, can reduce peak demands at a facility, such as changing the settings for devices (e.g., rolling blackouts, lowering the air conditioning, etc.), if configurable, in the facility; and/or switching the energy source for the devices during the peak hours to alternative energy sources (e.g., onsite generation of electricity, solar power, for the facility).

System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein. In many embodiments, operators and/or administrators of system 300 can manage system 300, the processor(s) of system 300, and/or the memory storage unit(s) of system 300 using the input device(s) and/or display device(s) of system 300, or portions thereof in each case.

In many embodiments, system 300 can include a system 310, a device(s) 320, a sensor(s) 330, and/or a database(s) 340. System 310 further can include one or more elements, modules, or systems, such as a machine learning model 3110, a long-term predicting module 3111, a short-term predicting module 3112, and/or an outlier-detection module 3120. System 310, device(s) 320, sensor(s) 330, machine learning model 3110, long-term predicting module 3111, short-term predicting module 3112, and/or an outlier-detection module 3120 can each be a computer system, such as computer system 100 (FIG. 1), as described above, and can each be a single computer, a single server, or a cluster or collection of computers or servers, or a cloud of computers or servers. In another embodiment, a single computer system can host system 310, device(s) 320, sensor(s) 330, machine learning model 3110, long-term predicting module 3111, short-term predicting module 3112, and/or an outlier-detection module 3120. Additional details regarding system 310, device(s) 320, sensor(s) 330, machine learning model 3110, long-term predicting module 3111, short-term predicting module 3112, and/or an outlier-detection module 3120 are described herein.

In some embodiments, system 310 can be in data communication with device(s) 320, and/or sensor(s) 330 using a computer network (e.g., computer network 350), such as the Internet and/or an internal network that is not open to the public. Meanwhile, in many embodiments, system 310 also can be configured to communicate with and/or include a database(s) 340. In some embodiments, database(s) 340 can include recent or real-time data (e.g., weather forecast data predicted in the past 24 hours and/or sensor data received within 3 hours, etc.). In several embodiments, database(s) 340 further can include historical data (e.g., historical weather data, historical sensor data, historical time-series data for energy consumption (energy load profiles) for a facility), as well as one or more training datasets (e.g., a long-term training dataset(s), a short-term training dataset(s), historical training data, etc.) and/or hyper-parameters for training and/or configuring system 310, machine learning model 3110, long-term predicting module 3111, short-term predicting module 3112, and/or an outlier-detection module 3120.

In a number of embodiments, database(s) 340 can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more data sources, that particular database can be stored on a single memory storage unit or the contents of that particular database can be spread across multiple ones of the memory storage units storing the one or more databases, depending on the size of the particular database and/or the storage capacity of the memory storage units. In similar or different embodiments, the one or more data sources can each be a computer system, such as computer system 100 (FIG. 1), as described above, and can each be a single computer, a single server, or a cluster or collection of computers or servers, or a cloud of computers or servers.

Database(s) 340 can include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

In many embodiments, communication between system 310, device(s) 320, sensor(s) 330, and/or database(s) 340 can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can determine demand shedding events for energy management and/or demand shedding time slots for performing the demand shedding events. Each demand shedding time slot can be a predicted time interval (e.g., 5 minutes, 10 minutes, 15 minutes, 30 minutes, or 1 hour, etc.) within an upcoming time period (e.g., the next 24 hours, 2 days, or 3 days, or next week, etc.) during which demand peaks/plateaus may happen, and demand shedding at a facility may be beneficial. Each demand shedding event can include one or more activities that can be performed to reduce energy consumption at the facility. For example, a demand shedding event can include changing the setting of an equipment (e.g., changing the set point temperature of the HVAC system (e.g., changing from 72° F. to 78° F.), dimming lights, etc.) and/or switching the energy source for a device to an alternative energy source (e.g., solar power, batteries, or generators, etc.).

In many embodiments, system 310 can determine, via a machine learning model (e.g., machine learning model 3110, a Polynomial Linear Regression (PLR) model, a spline regression model, a random forest model, a gradient boosting model, etc.), a predicted energy load profile for a facility based at least in part on weather forecast data and sensor data for the facility. In several embodiments, the sensor data can be received from sensor(s) 330 at the facility. In some embodiments, sensor(s) 330 can be associated with devices 320 at the facility (e.g., an HVAC meter in an HVAC system). The weather forecast data can include predictions regarding wind speed, humidity, and/or temperature that can be obtained periodically (e.g., hourly, daily, etc.) from a third-party service provider (e.g., the National Weather Service, the Weather Channel, AccuWeather, etc.). The sensor data can be received or retrieved periodically (e.g., every 5 minutes, 10 minutes, 15 minutes, an hour, etc.) from various energy monitoring sensors (e.g., sensor(s) 330) for the device(s) (e.g., device(s) 320) in a facility (e.g., a commercial building, a brick-and-mortar store, etc.). Examples of the energy monitoring sensors (e.g., sensor(s) 330) can include sub-meters (e.g., a main meter, an HVAC sub-meter, a refrigeration sub-meter, a lighting sub-meter, etc.) and/or a real-time equipment IoT (Internet of Things)-based telemetry. The frequency that the sensor data are collected can vary based on the types of the energy monitoring sensors. In some embodiments, the predicted energy load profile can be determined based on one or more factors, such as a size of the facility, one or more geographic features for the facility, a footfall of the facility, one or more assets for the facility, and/or operating hours for the facility, etc.

In a number of embodiments, the machine learning model (e.g., machine learning model 3110) can include an ensemble of a long-term predicting module (e.g., long-term predicting module 3111, a PLR model, etc.) and a short-term predicting module (e.g., short-term predicting module 3112, a random forest model, etc.). The long-term predicting module can be designed to capture the long-term relation between weather, IoT data, and energy consumption, while the short-term predicting module can be configured to capture the recent trend in energy consumption at the facility. System 310 can use this machine learning model to determine the predicted energy load profile by: (a) determining, via the long-term predicting module, a first portion of the predicted energy load profile based at least in part on the weather forecast data and the sensor data for the facility; and then (b) after determining the first portion, determining, via the short-term predicting module, a remaining portion of the predicted energy load profile based on residuals from the long-term predicting module. In many embodiments, system 310 further can combine the first portion and the remaining portion of the predicted energy load profile into a final predicted energy load profile.

In many embodiments, the machine learning model (e.g., machine learning model 3110), including the long-term predicting module (e.g., long-term predicting module 3111) and the short-term predicting module (e.g., short-term predicting module 3112), can be pre-trained or trained by system 310. In a number of embodiments, system 310 can train the long-term predicting module based on a long-term training dataset, which can be determined based on historical training data for the facility in a long-term time period (e.g., the last 1-5 years). System 310 further can train the short-term predicting module based on a short-term training dataset, which can include historical residuals in a short-term time period (e.g., the last 3-6 months) from training the long-term predicting module.

In some embodiments, outlier historical data can be detected and removed from the historical training data, based on any suitable approaches, before using the historical training data to train the machine learning model (e.g., machine learning model 3110). System 310 can detect outlier historical data of the historical training data for the machine learning model based on a rule-based, statistical, and/or machine learning-based approach(es). For example, system 310 can adopt one or more equipment-type-based rules (e.g., having different permissible ranges of sensor readings for different equipment, etc.). Equipment-type-based rules are generally useful for eliminating obvious abnormal data.

In certain embodiments, system 310 further can use one or more statistics-based rules for detecting outliers. For example, system 310 can monitor the standard deviation of energy load profiles (e.g., overall energy consumption and/or energy consumption of each device) to detect abnormal patterns in the load profiles (e.g., a constant energy consumption) caused by sensor errors. In a number of embodiments, system 310 additionally or alternatively can use an outlier-detection module (e.g., outlier-detection module 3120, a Local Outlier Factor model, a Density-Based Special Clustering of Application with Noise (DBSCAN) model, an isolation forest model, etc.) trained based on historical weather data, historical sensor data, and/or historical energy load profiles for the facility to identify outliers.

In many embodiments, system 310 further can determine one or more demand shedding time slots based at least in part on peak periods and the predicted energy load profile. In several embodiments, system 310 further can determine a cut-off threshold based on historical peak energy consumption data of historical energy load profiles (e.g., the actual peak consumption in the last 10, 15, 20, or 30 days), and then determine the one or more demand shedding time slots based on the predicted energy load profile, the cut-off threshold, and the peak periods. For example, when a cut-off threshold is determined based on the energy consumption in the past 14 days, and according to the predicted energy load profile for the prediction time period (e.g., the next 48 hours or 72 hours, etc.), the energy consumption during several time slots (e.g., 3:30-4:00 pm and 4:00-4:30 pm on the next day, and 4:00-4:30 pm on the day after the next day) can exceed the cut-off threshold, these time slots can be deemed the one or more demand shedding time slots.

In a number of embodiments, system 310 further can take into account any demand-shedding-deferring events. For example, system 310 can check the weather forecast in a subsequent time period after the prediction time period (e.g., the next 10 days or 15 days, etc. excluding the next 2 days) and determine whether more extreme weather conditions (e.g., ±20° F. hotter or colder days in the 3rd-15th day than the next 2 days, etc.) exist in the subsequent time period. If system 310 determines that deferring demand shedding at some of the demand shedding time slot candidates can be more beneficial (e.g., saving more energy, etc.), system 310 can defer demand shedding at those time slots by removing them from the one or more demand shedding time slots.

In similar or different embodiments, determining the one or more demand shedding time slots further can include: (a) determining whether a demand-shedding-deferring event exists in the weather forecast data; and (b) upon determining that the demand-shedding-deferring event exists, excluding at least one deferrable time slot in a deferring time period from the one or more demand shedding time slots. Determining whether the demand-shedding-deferring event exists further can include comparing a first portion and a second portion of the weather forecast data. The first portion can be associated with a time period of the predicted energy load profile (e.g., the prediction time period, the next 3 days or 5 days, etc.); and the second portion can be associated with a subsequent time period immediately following the time period (e.g., the subsequent 10 days following the prediction time period).

In many embodiments, system 310 further can determine one or more demand shedding events for the one or more devices (e.g., device(s) 320) to be scheduled during the one or more demand shedding time slots. The one or more demand shedding events can include any suitable events at a facility that can reduce power consumption, such as (a) changing a respective setting for at least one adjustable device (e.g., HVAC, or dimmable lighting, etc.) of the one or more devices during at least one of the one or more demand shedding time slots based at least in part on the predicted energy load profile; and/or (b) switching a respective energy source for at least one of the one or more devices during at least one of the one or more demand shedding time slots based on operating configurations of one or more alternative energy sources (e.g., batteries, on-site power generation, etc.) for the facility.

In many embodiments, system 310 further can cause a respective performance of each of the one or more demand shedding events by the one or more devices during the one or more demand shedding time slots. For example, system 310 can schedule an IoT-based remote control system (e.g., the battery management solution by Bosch, Driivz, etc.) to adjust the settings of the devices in the facility (e.g., the set point temperature of the HVAC device) at the one or more demand shedding time slots. In another example, system 310 can transmit a notice to or add calendar events with or without reminders for a store manager at the facility to change the setting for devices in the facility.

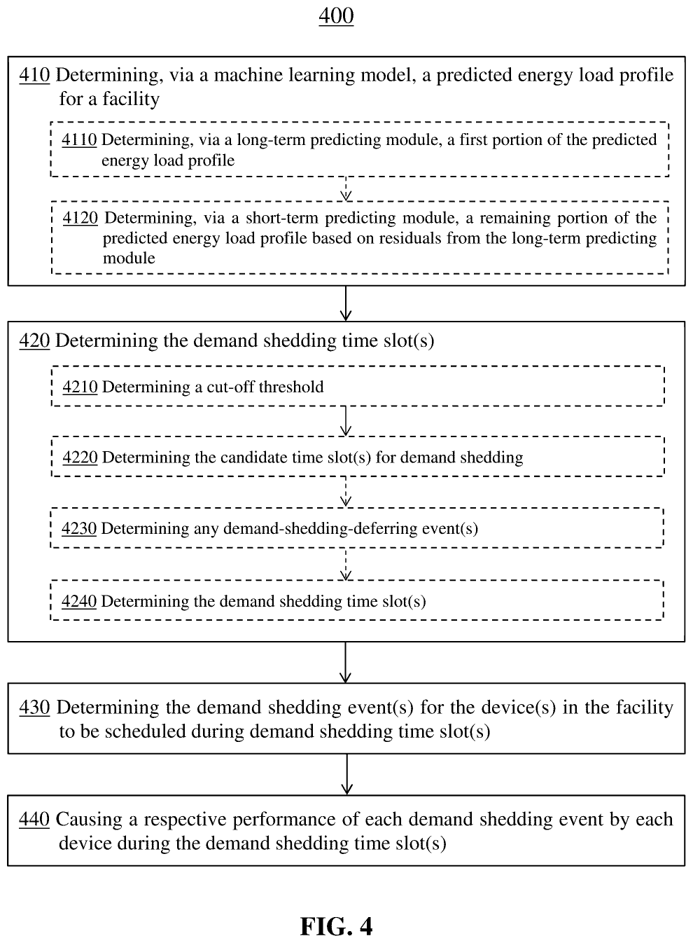

Turning ahead in the drawings, FIG. 4 illustrates a flow chart for a method 400 of extracting information from multiple partial images, according to an embodiment. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3) or system 310 (FIG. 3) (including one or more of its elements, modules, and/or systems, such as machine learning model 3110 (FIG. 3)) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) or system 310 (FIG. 3). The processor(s) can be similar or identical to the processor(s) described above with respect to computer system 100 (FIG. 1).

Referring to FIG. 4, method 400 can include a block 410 of determining, via a machine learning model (e.g., machine learning model 3110 (FIG. 3)), a predicted energy load profile for a facility (e.g., a brick-and-mortar store, a factory, etc.) for a time period (e.g., the next 24 hours, 48 hours, 72 hours, etc.). The machine learning model can include an ensemble of multiple machine learning modules. In some embodiments, machine learning model can include an ensemble of a long-term predicting module and a short-term predicting module. Block 410 further can include a block 4110 of determining, via the long-term predicting module (e.g., long-term predicting module 3111 (FIG. 3), a PLR model, etc.) a first portion of the predicted energy load profile (e.g., an energy load profile of the past year, 2 years, or 3 years, etc.). In certain embodiments, block 410 further can include a block 4120 of determining, via a short-term predicting module (e.g., short-term predicting module 3112 (FIG. 3), a random forest model, etc.), a remaining portion of the predicted energy load profile based on residuals from the long-term predicting module (e.g., an energy load profile of the past 2 months, 4 moths, or 5 months, etc.).

In many embodiments, method 400 further can include a block 420 of determining the one or more demand shedding time slots based at least in part on peak periods and the predicted energy load profile, as determined in block 410. The peak periods can be determined from the predicted energy load profile. In some embodiments, block 420 further can include a block 4210 of determining a cut-off threshold based on historical peak energy consumption data of historical energy load profiles (e.g., the historical energy load profiles in the past 10 days, 14 days, 15 days, or 20 days, etc.). Block 420 further can include a block 4220 of determining the one or more candidate time slots for demand shedding based on the predicted energy load profile, the cut-off threshold determined in block 4210, and the peak periods. That is, the one or more candidate time slots are among the peak periods where the respective predicted energy consumption for each candidate time slot on the predicted energy load profile is above the cut-off threshold.

In a number of embodiments, block 420 further can include a block 4230 of determining any demand-shedding-deferring events (e.g., hotter or colder days in a subsequent time period immediately following the time period for the predicted energy load profile). The subsequent time period can be the 4th-10th days in the future, as an example, when the time period for the predicted energy load profile includes the next 3 days.

In some embodiments, block 420 further can include a block 4240 of determining the one or more demand shedding time slots based on the one or more candidate time slots determined in block 4220 and/or the one or more demand-shedding-deferring events determined in block 4210. In several embodiments, once at least one demand-shedding-deferring event is predicted, block 4240 further can remove some time slots among the one or more candidate time slots when demand shedding for each of the some time slots is not as beneficial (e.g., because the temperature is not as high, etc.) as demand shedding at each time slot associated with each of the at least one demand-shedding-deferring event.

Still referring to FIG. 4, method 400 further can include a block 430 of determining the one or more demand shedding events for the devices in the facility to be scheduled during one or more demand shedding time slots determined in block 420. The one or more demand shedding events for the devices can be similar or different from the demand shedding events described above.

In many embodiments, method 400 additionally can include a block 440 of causing a respective performance (e.g., scheduling the automatic changes of the settings or energy sources for each device or instructing a person to change the settings or energy sources onsite, etc.) of each demand shedding event by each device during the one or more demand shedding time slots.

Various embodiments can include a system for predicting energy load profiles and recommending demand shedding events for energy management. The system can include one or more processors and one or more non-transitory computer-readable media storing computing instructions configured to, when run on the one or more processors, cause the one or more processors to perform various acts. The acts can include determining, via a machine learning model, a predicted energy load profile for a facility based at least in part on weather forecast data and sensor data for the facility. The sensor data can be received from one or more energy monitoring sensors for one or more devices in the facility. In some embodiments, the acts further can include determining one or more demand shedding time slots based at least in part on peak periods and the predicted energy load profile. In addition, the acts can include determining one or more demand shedding events for the one or more devices to be scheduled during the one or more demand shedding time slots. In many embodiments, the acts further can include causing a respective performance of each of the one or more demand shedding events by the one or more devices during the one or more demand shedding time slots.

Various embodiments further can include a method being implemented via execution of computing instructions configured to run at one or more processors and stored at one or more non-transitory computer-readable media. The method can include determining, via a machine learning model, a predicted energy load profile for a facility based at least in part on weather forecast data and sensor data for the facility. The sensor data can be received from one or more energy monitoring sensors for one or more devices in the facility. The method further can include determining one or more demand shedding time slots based at least in part on peak periods and the predicted energy load profile. The method also can include determining one or more demand shedding events for the one or more devices to be scheduled during the one or more demand shedding time slots. Moreover, the method can include causing a respective performance of each of the one or more demand shedding events by the one or more devices during the one or more demand shedding time slots.

In many embodiments, the techniques described herein can provide a practical application and several technological improvements. The techniques described herein can use a stacking approach to predict energy load profile a couple of days ahead and provide proactive energy management recommendations. These techniques described herein can provide a significant improvement over conventional approaches. Some conventional approaches use rule-based thresholds to trigger demand shedding events, and the thresholds often do not capture real peaks. Other conventional approaches rely on the predictions made based on real-time data and thus cannot provide energy load predictions in time for demand shedding events to be scheduled and/or executed. For example, electricity providers generally predict when and where demand peaks may occur only a few minutes or hours in advance based on real-time total market energy demand. Very often when customers (e.g., stores) receives notices that demand peaks are about to happen, they may not have enough time to react because the execution of demand shedding events takes time.

Although predicting energy load profiles and recommending demand shedding events for energy management have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-4 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders. As another example, the modules, elements, and/or systems within system 300 or system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when run on the one or more processors, cause the one or more processors to perform:
determining, via a machine learning model, a predicted energy load profile for a facility based at least in part on weather forecast data and sensor data for the facility, wherein:
the sensor data are received from one or more energy monitoring sensors for one or more devices in the facility;
determining one or more demand shedding time slots based at least in part on peak periods and the predicted energy load profile;
determining one or more demand shedding events for the one or more devices to be scheduled during the one or more demand shedding time slots; and
causing a respective performance of each of the one or more demand shedding events by the one or more devices during the one or more demand shedding time slots.

2. The system in claim 1, wherein:
the machine learning model comprises an ensemble of a long-term predicting module and a short-term predicting module.

3. The system in claim 2, wherein determining, via the machine learning model, the predicted energy load profile further comprises:
determining, via the long-term predicting module, a first portion of the predicted energy load profile based at least in part on the weather forecast data and the sensor data for the facility; and
after determining the first portion, determining, via the short-term predicting module, a remaining portion of the predicted energy load profile based on residuals from the long-term predicting module.

4. The system in claim 2, wherein:
the long-term predicting module is trained based on a long-term training dataset;
the short-term predicting module is trained based on a short-term training dataset;
the long-term training dataset is determined based on historical training data for the facility in a long-term time period; and
the short-term training dataset comprises historical residuals in a short-term time period from training the long-term predicting module.

5. The system in claim 4, wherein the computing instructions, when run on the one or more processors, further cause the one or more processors to perform:
detecting outlier historical data of the historical training data based on one or more of:
one or more equipment-type-based rules;
one or more statistics-based rules; or
an outlier-detection module trained based on one or more of: historical weather data, historical sensor data, or historical energy load profiles for the facility; and
removing the outlier historical data from the historical training data.

6. The system in claim 1, wherein determining, via the machine learning model, the predicted energy load profile further comprises determining, via the machine learning model, the predicted energy load profile based on one or more of:
a size of the facility;
one or more geographic features for the facility;
a footfall of the facility;
one or more assets for the facility; or
operating hours for the facility.

7. The system in claim 1, wherein determining the one or more demand shedding time slots further comprises:
determining a cut-off threshold based on historical peak energy consumption data of historical energy load profiles; and
determining the one or more demand shedding time slots based on the predicted energy load profile, the cut-off threshold, and the peak periods.

8. The system in claim 7, wherein determining the one or more demand shedding time slots further comprises:
determining whether a demand-shedding-deferring event exists in the weather forecast data; and
upon determining that the demand-shedding-deferring event exists, excluding at least one deferrable time slot in a deferring time period from the one or more demand shedding time slots.

9. The system in claim 8, wherein:
determining whether the demand-shedding-deferring event exists further comprises comparing a first portion and a second portion of the weather forecast data;
the first portion is associated with a time period of the predicted energy load profile; and
the second portion is associated with a subsequent time period immediately following the time period.

10. The system in claim 1, wherein:
the one or more demand shedding events for the one or more devices to be scheduled during the one or more demand shedding time slots further comprises one or more of:
changing a respective setting for at least one adjustable device of the one or more devices during at least one of the one or more demand shedding time slots based at least in part on the predicted energy load profile; or
switching a respective energy source for at least one of the one or more devices during at least one of the one or more demand shedding time slots based on operating configurations of one or more alternative energy sources for the facility.

11. A method being implemented via execution of computing instructions configured to run at one or more processors and stored at one or more non-transitory computer-readable media, the method comprising:
determining, via a machine learning model, a predicted energy load profile for a facility based at least in part on weather forecast data and sensor data for the facility, wherein:
the sensor data are received from one or more energy monitoring sensors for one or more devices in the facility;
determining one or more demand shedding time slots based at least in part on peak periods and the predicted energy load profile;
determining one or more demand shedding events for the one or more devices to be scheduled during the one or more demand shedding time slots; and
causing a respective performance of each of the one or more demand shedding events by the one or more devices during the one or more demand shedding time slots.

12. The method in claim 11, wherein:
the machine learning model comprises an ensemble of a long-term predicting module and a short-term predicting module.

13. The method in claim 12, wherein determining, via the machine learning model, the predicted energy load profile further comprises:
determining, via the long-term predicting module, a first portion of the predicted energy load profile based at least in part on the weather forecast data and the sensor data for the facility; and
after determining the first portion, determining, via the short-term predicting module, a remaining portion of the predicted energy load profile based on residuals from the long-term predicting module.

14. The method in claim 12, wherein:
the long-term predicting module is trained based on a long-term training dataset;
the short-term predicting module is trained based on a short-term training dataset;
the long-term training dataset is determined based on historical training data for the facility in a long-term time period; and
the short-term training dataset comprises historical residuals in a short-term time period from training the long-term predicting module.

15. The method in claim 14, further comprising:
detecting outlier historical data of the historical training data based on one or more of:
one or more equipment-type-based rules;
one or more statistics-based rules; or
an outlier-detection module trained based on one or more of: historical weather data, historical sensor data, or historical energy load profiles for the facility; and
removing the outlier historical data from the historical training data.

16. The method in claim 11, wherein determining, via the machine learning model, the predicted energy load profile further comprises determining, via the machine learning model, the predicted energy load profile based on one or more of:
a size of the facility;
one or more geographic features for the facility;
a footfall of the facility;
one or more assets for the facility; or
operating hours for the facility.

17. The method in claim 11, wherein determining the one or more demand shedding time slots further comprises:
determining a cut-off threshold based on historical peak energy consumption data of historical energy load profiles; and
determining the one or more demand shedding time slots based on the predicted energy load profile, the cut-off threshold, and the peak periods.

18. The method in claim 17, wherein determining the one or more demand shedding time slots further comprises:
determining whether a demand-shedding-deferring event exists in the weather forecast data; and
upon determining that the demand-shedding-deferring event exists, excluding at least one deferrable time slot in a deferring time period from the one or more demand shedding time slots.

19. The method in claim 18, wherein:
determining whether the demand-shedding-deferring event exists further comprises comparing a first portion and a second portion of the weather forecast data;
the first portion is associated with a time period of the predicted energy load profile; and
the second portion is associated with a subsequent time period immediately following the time period.

20. The method in claim 11, wherein:
the one or more demand shedding events for the one or more devices to be scheduled during the one or more demand shedding time slots further comprises one or more of:
changing a respective setting for at least one adjustable device of the one or more devices during at least one of the one or more demand shedding time slots based at least in part on the predicted energy load profile; or
switching a respective energy source for at least one of the one or more devices during at least one of the one or more demand shedding time slots based on operating configurations of one or more alternative energy sources for the facility.
